(19) United States
(12) Patent Application Publication
(10) Pub. No.: US 2026/0310958 A1
(43) Pub. Date: Oct. 8, 2026

(54) METHODS TO UPDATE, REQUEST, AND SHARE A TRAINING DATESET

(71) Applicant: InterDigital Patent Holdings, Inc., Wilmington, DE (US)

(72) Inventors: Patrick TOOHER, Montreal (CA); Yugeswar Deenoo NARAYANAN THANGARAJ, Chalfont, PA (US); Tejaswinee LUTCHOOMUN, Montreal (CA); Akshay MALHOTRA, San Jose, CA (US); Mihaela BELURI, Jericho, NY (US); Mohamed Salah IBRAHIM, Chesterbrook, PA (US); Anouar YATRIBI, London (GB)

(73) Assignee: InterDigital Patent Holdings, Inc., Wilmington, DE (US)

(21) Appl. No.: 19/479,503

(22) PCT Filed: May 9, 2024
(86) PCT No.: PCT/US2024/028483

§ 371 Date: Oct. 28, 2025

Related U.S. Application Data
(60) Provisional application No. 63/465,090, filed on May 9, 2023.

(51) Int. Cl. G06N 3/08

(52) U.S. Cl. CPC G06N 3/08

(57) ABSTRACT

A method performed by a wireless transmit/receive unit (WTRU) may comprise: receiving configuration information, wherein the configuration information includes a AI/ML model and a first dataset, wherein the first dataset is associated with a first network node; receiving a second data set associated with a second network node; generating a third dataset from the first dataset and second dataset; training the AI/ML model with the third dataset; generating a fourth dataset from the third dataset; and transmitting the fourth dataset to at least one of the first network node or the second network node. The WTRU may be triggered to update the AI/ML model to operate with the second network node.

### CROSS-REFERENCE TO RELATED APPLICATIONS

This application claims the benefit of U.S. Provisional Application No. 63/465,090, filed May 9, 2023, the contents of which are incorporated herein by reference.

### BACKGROUND

Two-sided artificial intelligent/machine learning (AI/ML) models (e.g., autoencoders), where a AI/ML encoder is used at a first node (e.g., a WTRU) and an AI/ML decoder is used at a second node (e.g., the base station), enable such things as CSI compression and CSI prediction.

Training of AI/ML models may be performed offline, prior to deploying the models at the nodes (WTRUs and/or base station). During regular operation (i.e., at inference time), the performance of the two-sided AI/ML model may degrades. This degradation may happen, for example, when the distribution of the actual data does not match the distribution of the training dataset, or when there is a model mismatch between the AI/ML encoder and the AI/ML decoder. If the performance of the two-sided model degrades, retraining and/or finetuning of the model(s) based on updated datasets may be used to mitigate the performance degradation. AI/ML models may or may not be shared among nodes or different vendors. Therefore, training of two-sided AI/ML models may require information exchange among different nodes of a network.

### SUMMARY

A method performed by a wireless transmit/receive unit (WTRU) may comprise: receiving configuration information, wherein the configuration information includes a AI/ML model and a first dataset, wherein the first dataset is associated with a first network node; receiving a second data set associated with a second network node; generating a third dataset from the first dataset and second dataset; training the AI/ML model with the third dataset; generating a fourth dataset from the third dataset; and transmitting the fourth dataset to at least one of the first network node or the second network node. The WTRU may be triggered to update the AI/ML model to operate with the second network node.

The third dataset may be based on a combination of the first dataset and the second dataset. The generation of the third dataset may be based on a redundancy reduction, a randomized selection, or a previously used dataset.

The method may further comprise selecting one or more samples from the third dataset. The selection of the one or more samples from the third dataset may include selecting dataset samples that satisfy a dataset similarity comparison threshold. The selection of the one or more samples from the third dataset may include selecting dataset samples that maximize a gradient when training the AI/ML model. The selection of the one or more samples from the third dataset may include selecting dataset samples that were not previously shared with the first network node. The fourth dataset may be generated from the selected one or more samples of the third dataset.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a two-sided AI/ML model;

FIGS. 3A-3C illustrates an example of AI/ML model training cases;

FIGS. 4A-4D illustrates an example procedure of a dataset construction and sharing to enable a generalized WTRU-side AI/ML model;

FIG. 5 is flowchart illustrating an example procedure performed by a WTRU;

FIG. 6 is a flowchart illustrating an example procedure for a suitability evaluation based on comparing newly generated dataset samples with dataset used for original training; and

FIG. 7 is flowchart illustrating an example procedure performed by a WTRU.

### DETAILED DESCRIPTION

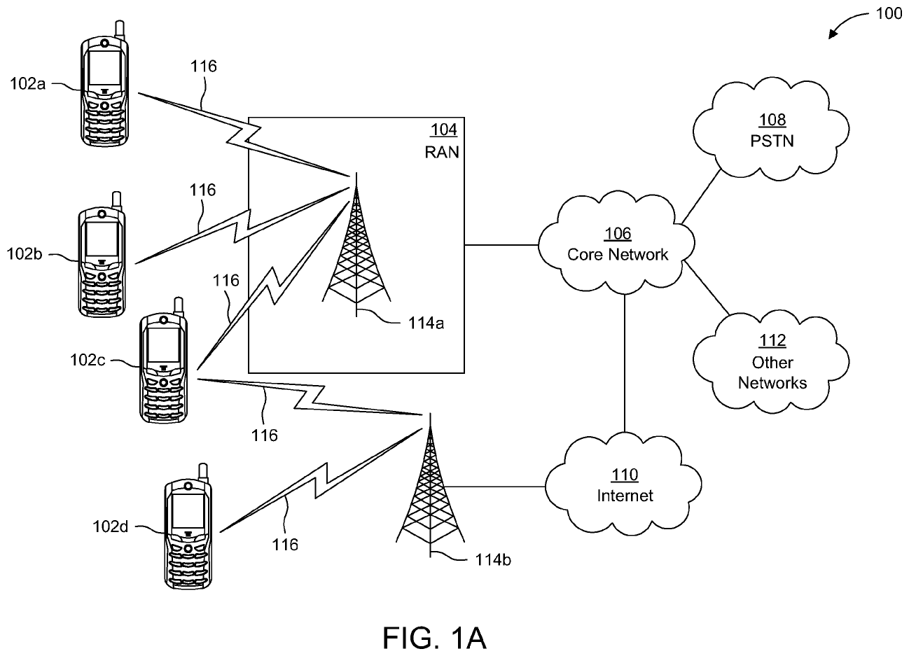

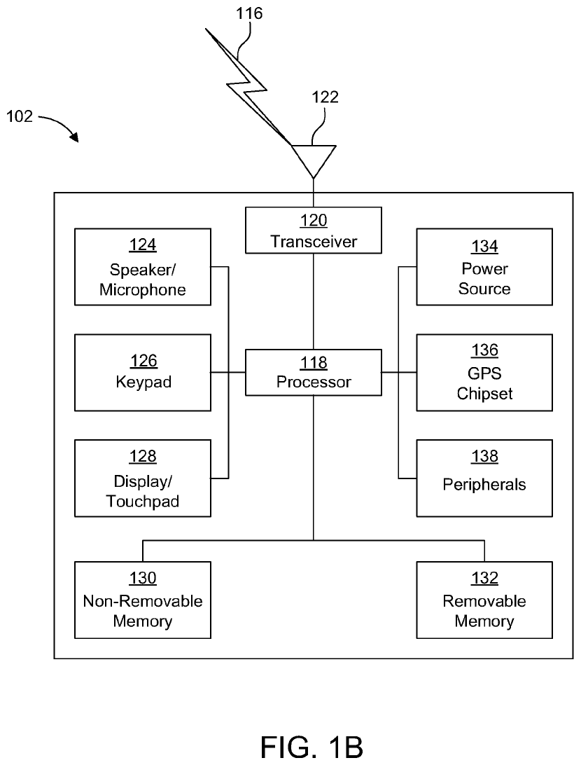

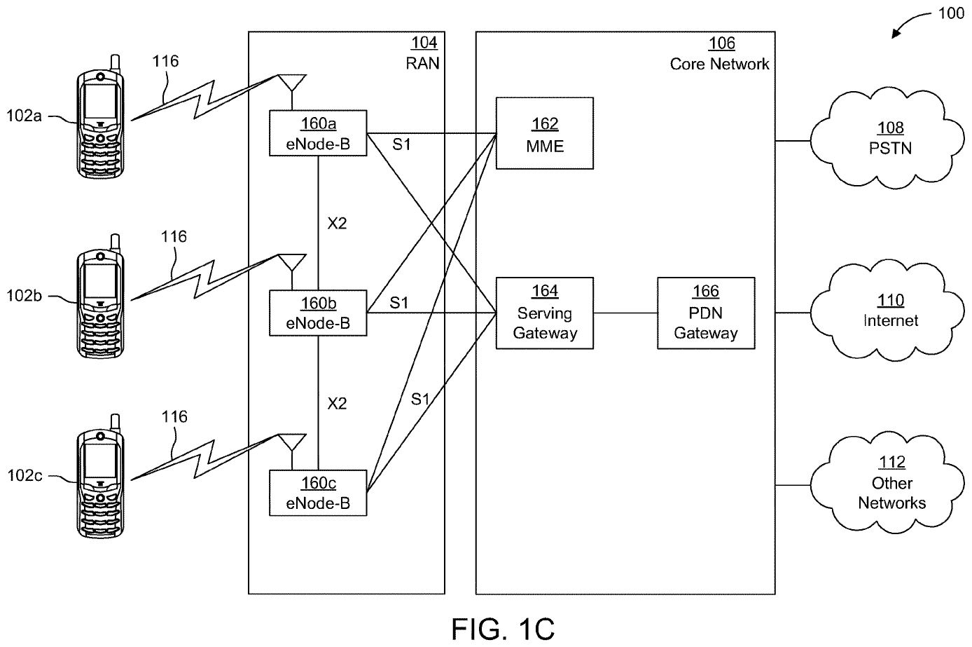

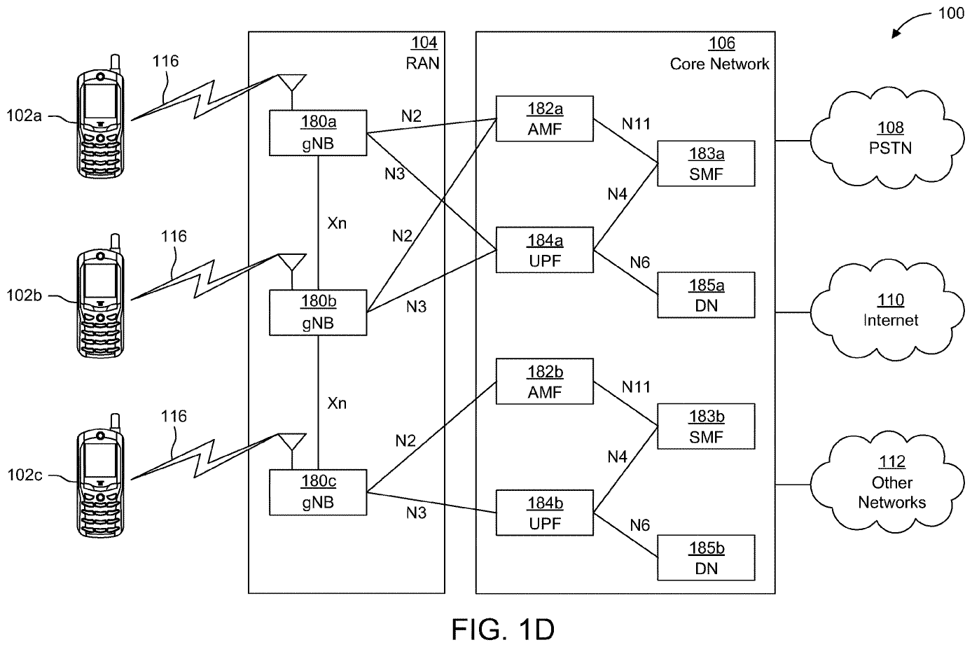

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S—2-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms may be referred to:
ACK Acknowledgement
AE Autoencoder
AI/ML Artificial Intelligence/Machine Learning
AoA Angle of Arrival
AoD Angle of Departure
BLER Block Error Rate
BWP Bandwidth Part
CAP Channel Access Priority
CAPC Channel access priority class
CCA Clear Channel Assessment
CCE Control Channel Element
CE Control Element
CG Configured grant or cell group
CO Channel Occupancy
CP Cyclic Prefix
CP-OFDM Conventional OFDM (relying on cyclic prefix)
CQI Channel Quality Indicator
CR Cyclic Redundancy Check
CRI CSI Reference Signal Resource Indicator
CSI Channel State Information
CW Contention Window
CWS Contention Window Size
DAI Downlink Assignment Index
DCI Downlink Control Information
DFI Downlink feedback information
DG Dynamic grant
DL Downlink
DM-RS Demodulation Reference Signal
DRB Data Radio Bearer
eLAA enhanced Licensed Assisted Access
FeLAA Further enhanced Licensed Assisted Access
HARQ Hybrid Automatic Repeat Request
LAA License Assisted Access
LBT Listen-Before-Talk
LI Layer Indicator
LTE Long Term Evolution e.g. from 3GPP LTE R8 and up
MCS Modulation and Coding Scheme
MIMO Multiple Input Multiple Output
NACK Negative ACK
NMSE Normalized Mean Squared Error
NR New Radio
OFDM Orthogonal Frequency-Division Multiplexing
PHY Physical Layer
PID Process ID
PMI Precoding Matrix Indicator
PO Paging Occasion
PRACH Physical Random Access Channel
PSS Primary Synchronization Signal
RA Random Access (or procedure)
RACH Random Access Channel
RAR Random Access Response
RCU Radio access network Central Unit
RF Radio Front end
RI Rank Indicator
RLF Radio Link Failure
RLM Radio Link Monitoring
RNTI Radio Network Identifier
RO RACH occasion
RRC Radio Resource Control
RRM Radio Resource Management
RS Reference Signal
RSRP Reference Signal Received Power
RSSI Received Signal Strength Indicator
SDU Service Data Unit
SGCS Squared Generalized Cosine Similarity
SPS Semi-persistent scheduling
SRS Sounding Reference Signal
SS Synchronization Signal
SSS Secondary Synchronization Signal
SUL Supplemental Uplink
SWG Switching Gap (in a self-contained subframe)
TB Transport Block
TBS Transport Block Size
TRE Transmission/Reception Point
TSC Time-sensitive communications
TSN Time-sensitive networking
UL Uplink
URLLC Ultra-Reliable and Low Latency Communications
WBWP Wide Bandwidth Part

As used herein, the terms AI/ML model training, or AI/ML model retraining, or AI/ML model updating, or AI/ML model fine-tuning may be used interchangeably unless stated otherwise.

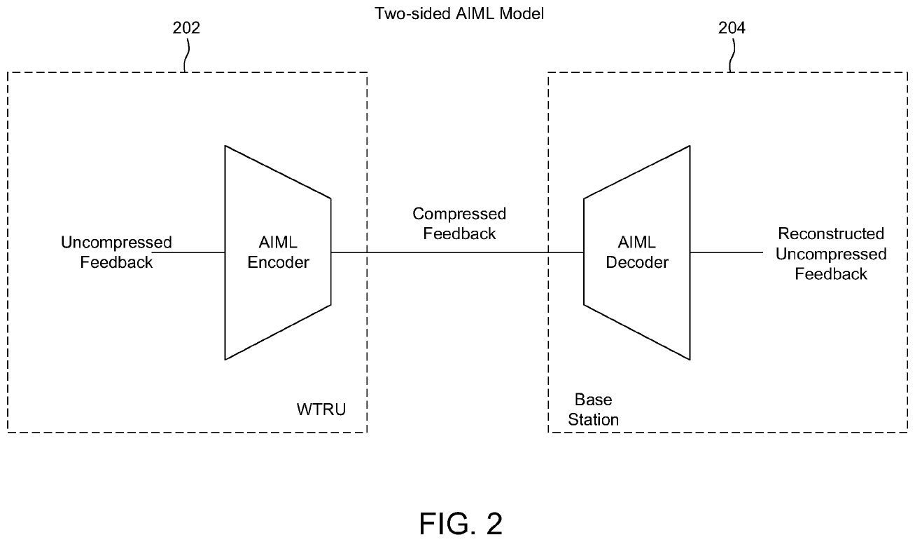

FIG. 2 illustrates a two-sided AI/ML model. A shown in FIG. 2, uncompressed feedback is inputted into the WTRU 202 (i.e., AI/ML encoder). The uncompressed feedback may be, for example, channel conditions (e.g., CSI). The uncompressed feedback may also be feedback related to location-based data, application performance, and/or security and privacy. The WTRU 202 then compresses the feedback and sends it to the network 204 (i.e., AI/ML decoder). The network 204 may then decode and reconstruct the compressed feedback.

Training of the AI/ML models may be performed offline, prior to deploying the models at the nodes (e.g., WTRU(s) and/or base station). During regular operation (i.e., at inference time), it is possible that the performance of the two-sided AI/ML model degrades. The degradation may happen, for example, when the distribution of the actual data does not match the distribution of the training dataset, or when there is a model mismatch between the AI/ML encoder and the AI/ML decoder. If the performance of the two-sided model degrades, retraining and/or finetuning the model(s), based on updated datasets, may be used to mitigate the performance degradation.

AI/ML models may or may not be shared among nodes or different vendors. Therefore, training of two-sided AI/ML models may require information exchange among different nodes of a network.

For CSI compression using two-sided models, the following two AI/ML model may be available: (1) joint training of the two-sided model (e.g., AE) at a single side/node (e.g. WTRU or base station); and (2) joint training of the two-sided model (e.g., AE) at the WTRU side and the NW side, respectively.

In the joint training of the two-sided model at a single side/node, the training may be performed offline, before mode deployment. Jointly training the AI/ML encoder and AI/ML decoder in the same loop for forward and backward propagation is may be optimal in terms of eventual model performance, but it may not be feasible to train in the same loop models from different vendors.

Joint training of the two-sided model at the WTRU side and NW side, the AI/ML encoder model residing at the WTRU-side is trained jointly with the ML decoder model residing at the NW-side, with exchange of information (e.g., gradients) between the nodes. This training may be performed offline, but if the AI/ML models are from different vendors, the training may need to be hosted on a secure third party platform to preserve security and vendor proprietary information. The complexity of training on a third-party platform may increase as the number of vendors and AI/ML models increase. This training may also be performed online, which may address the model confidentiality concerns, while at the same time significantly increasing the over-the-air overhead.

Separate sequential training, where a two-sided ML model is trained at a single node first, then training information, which may include a training dataset, may be shared with the second node for training the two-sided model at the second node. For example, in the WTRU-first case training, the WTRU may train its AI/ML (e.g., proprietary) encoder using a generic AI/ML decoder model and a training dataset. The WTRU may send training information to the NW node, which will then train its ML (e.g., proprietary) decoder using a generic ML encoder and the training dataset shared by the WTRU. In the NW-first case training, the NW may train its ML (e.g., proprietary) decoder using a generic AI/ML encoder model and a training dataset. The NW may send training information to the WTRU node, which will then train its AI/ML (e.g., proprietary) encoder using a generic AI/ML decoder and the training dataset shared by the NW.

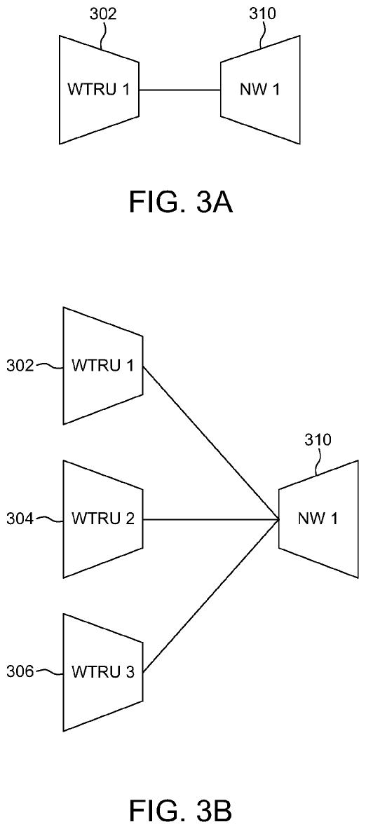

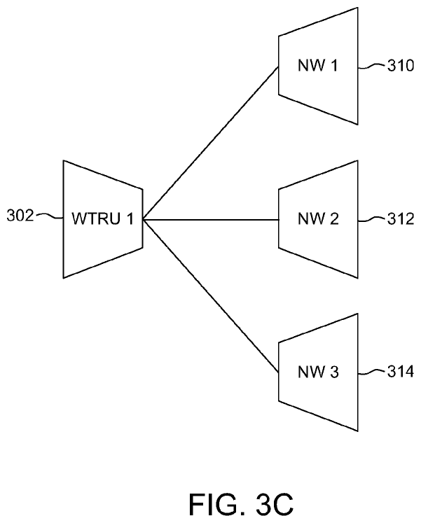

FIGS. 3A and 3B illustrate separate sequential training. FIG. 3A illustrates a first scenario that includes a single WTRU (i.e., WTRU 302) part model and a single NW (i.e., NW 310) part model. This first scenario may be applicable to WTRU-first or NW-first training.

FIG. 3B illustrates a second scenario where there are three WTRU part models (i.e., WTRU 302, WTRU 304, and WTRU 306) and a single NW 310 part model. This second scenario may be applicable to WTRU-first training.

FIG. 3C illustrates a third scenario where there is a single WTRU model (i.e., WTRU 302) and one or more separate WTRU part models (i.e., NW 310, NW 312, and NW 314). This third scenario may be applicable to NW-first training.

Methods to train a two-sided AI/ML model are required. In some instances, a WTRU may not have access to a NW-side AI/ML model decoder and/or the NW may not have access to a WTRU-side AI/ML model encoder. Furthermore, in some cases a model at one end must generalize to work with multiple models at the other end, potentially from different vendors. In these cases, the models cannot be wholly trained at one node. Therefore, methods to train two-sided AI/ML models separately at both nodes is needed.

Training of AI/ML models may require known datasets. In order for a two-sided model to be trained, relevant datasets must be generated and shared among nodes. Methods are required to determine and share datasets at nodes using two-sided AI/ML models.

Furthermore, two-sided AI/ML model performance may degrade due to changes at one of the two nodes. Performance degradation may lead to the need to retrain at least one side of the two-sided AI/ML model. Therefore, methods to determine when to trigger training/retraining/updating/fine-tuning of at least one side of a two-sided AI/ML model may be required.

A two-sided AI/ML model may be composed of two parts. The first part, or AI/ML encoder, may generate a latent space output from an input. The second part, or AI/ML decoder, may use the encoder's latent space output as an input, and the output of the decoder may be deemed the reconstructed input. The encoder part of the AI/ML model may be located at a first node(e.g. the WTRU), and the decoder part of the AI/ML model may be located at a second node(e.g. the NW or base station). Herein, the terms NW, node, base station, and gNB may be used interchangeably.

An AI/ML model, that is one or both parts of a two-sided AI/ML model, may be defined by at least one of: a structure, a set of parameters, and an input or output type. For example, an AI/ML model structure may be at least one of: autoencoder, neural network, deep neural network, recurrent neural network, transformer, convolutional neural network, and/or stochastic neural network. The set of parameters may include the number of hidden nodes, size or number of layers, weights, hyperparameters of an AI/ML model.

The input or output type. Th input type and/or output type may include the number of inputs or outputs of an AI/ML encoder or decoder. This may include the type of input or output of an AI/ML encoder or decoder. For example, the inputs of an AI/ML encoder may include CSI measurements or set of eigenvectors. The AI/ML encoder outputs may include compressed measurements. The AI/ML decoder input may include compressed measurements possibly in addition to an error (e.g., due to wireless channel noise or interference). The AI/ML decoder output may include a reconstructed CSI measurement or set of eigenvectors. Ideally, the AI/ML decoder output should match a known function of the AI/ML encoder input.

A WTRU may receive or be configured with a dataset. In another method, a WTRU may generate a dataset. For example, a WTRU may perform one or more measurements and may associate the one or more measurement values to one or more indicated or WTRU-determined parameters. Such one or more measurements and none or more associated parameters may form an element or a sample of a dataset. For example, a WTRU may perform a CSI measurement and associate it with a measured or determined position to determine an element of a dataset. A dataset may be used by a node to train an AI/ML model (or AI/ML encoder or AI/ML decoder).

A dataset may include at least one of: a dataset index; a measurement type; a pair of associated measurement types; a paired input-output; a paired output-reconstructed input; set of dataset parameters; and trigger CSI.

A dataset index may be used to identify a pre-existing or configured dataset.

With respect to a measurement type, for example, a dataset may include a set of possible CSI or RRC measurements (e.g., RSRP, RSRQ, RSSI, RI, PMI, CQI, PMI, LI, CRI, CO, delay spread, average delay, doppler shift, doppler spread, AoA, AoD). The measurement types may be raw measurements (e.g., channel matrix) or a set of eigenvectors. The measurement types may be filtered over multiple measurement instances.

A pair of associated measurement types may include, for example, an RSRP measurement with a WTRU position. paired input-output may include, for example, an AI/ML encoder that uses an input to generate an output. The input-output pair may constitute an element of a dataset. The input or output may be defined as a value (e.g., measurement value) or as an index to a set of known values.

A paired output-reconstructed input may include, for example, an AI/ML decoder that uses an output (e.g., an output of an AI/ML encoder or an output of an AI/ML encoder with noise or interference) to generate a reconstructed input. The output or reconstructed inputs may be defined as a value (e.g., measurement value) or as an index to a set of known values.

A dataset parameter may include at least one of: a scenario (e.g., indoor or outdoor, moving non-moving WTRU, LOS or NLOS, etc.), a configuration (e.g., a beam pair, number of antenna ports (Tx or Rx), antenna port configuration, a BWP, a frequency region, etc.), a function (e.g., CSI feedback, beam management, positioning, power control, channel coding, LCP, DRX, RRM, RLM, BFD, etc.), an associated model (e.g., an encoder model associated with a decoder model), or an associated node (e.g., a NW node associated with a WTRU node).

A WTRU may be configured to perform one or more actions associated with dataset, possibly as a function of one or more NW-side AI/ML model(s). The actions may include one or more of constructing, collecting, receiving, processing, updating, selecting, filtering, quantizing, compressing, encoding, transmitting, dataset or parts thereof. The WTRU may be configured to apply the resulting dataset for training, re-training, and/or fine-turning WTRU-side AI/ML model, potentially for joint operation with the NW-side AI/ML model.

A WTRU may be configured with a first dataset. The first dataset may be associated with a joint operation for a WTRU side AI/ML model and a first NW side model. The WTRU may be configured to receive the first dataset from the NW. The WTRU may be configured to use the first dataset for the sequential training of WTRU side model. The WTRU may be configured with additional information associated with first dataset wherein the additional information may include applicable scenario, configuration, deployment, applicable cell/site/area/zone etc. In a solution, the WTRU may be configured to derive the first dataset or parts thereof based on WTRU measurements. The WTRU measurements may be associated with the first NW node.

The WTRU may be configured to derive a second dataset. The second dataset may be associated with a joint operation of WTRU side AI/ML model and a second NW side model. The WTRU may be configured to receive the second dataset from the NW. The WTRU may be configured with additional information associated with second dataset wherein the additional information may include applicable scenario, configuration, deployment, applicable cell/site/area/zone etc. The WTRU may be configured to derive the second dataset or parts thereof, based on WTRU measurements. The WTRU measurements may be associated with the second NW node.

The WTRU may be configured to construct a third dataset. The third dataset may be a function of the first dataset and the second dataset. The WTRU may be configured with rules to derive the third dataset based on the first and second dataset. One or more solutions herein are described assuming a third dataset is constructed based on first and second dataset as examples. It should be noted that the solutions are equally applicable for any general case where M datasets are constructed based on N datasets, wherein M>=1 and N>=1.

The WTRU may be configured with a maximum size for the third dataset. The WTRU may be configured to combine the first and second dataset such that the third dataset does not exceed the maximum size preconfigured for a third dataset. The WTRU may be configured with a maximum size threshold for each of the datasets (e.g., first dataset and second dataset)that constitute the third dataset. The WTRU may be configured to derive the third dataset such that each of the constituent datasets (e.g., first and second dataset), doesn't exceed the maximum size threshold set for constituent datasets. In a solution, the max size of constituent dataset size may be expressed as the function of maximum size of third dataset and the number of constituent dataset size. In a solution, the WTRU may be configured with minimum size for each of the constituent dataset. For example, the WTRU may be configured to ensure that at least the minimum size of each constituent datasets is included in the third dataset.

The WTRU may be configured to construct the third dataset with a weighted combination of the first dataset and second dataset. For example, the weight here may control the determination of number of samples from constituent datasets that make up the third dataset. The WTRU may determine the weight associated with each of the constituent datasets as a function of age of the dataset. For example, weights can be adjusted/preconfigured to prioritize newer datasets/measurements. For example, the WTRU may select the larger number of samples from newer dataset than older dataset. The WTRU may be configured with priority associated each of the constituent dataset. For example, the WTRU may be configured to follow the preconfigured prioritization rules when selecting samples from constituent datasets.

The WTRU may be configured to select the constituent dataset(s) as a function of applicable conditions. For example, the WTRU may be configured with association between dataset and one or more applicable conditions. For example, applicable conditions may include scenario, configuration (e.g., carrier frequency, bandwidth, antenna configuration), WTRU measurements (e.g., doppler, SINR range, rank,) deployment, cell/site/area/zone etc. The WTRU may be configured to select the constituent dataset such that the applicable conditions associated with dataset match the applicable conditions associated with the NW side AI/ML model.

The WTRU may be configured with a dataset with special handling for dataset construction. Possibly such configuration may be an optional configuration. For example, the dataset may be a default dataset. For example, the WTRU may be configured to include the samples from default dataset irrespective of other rules/conditions described herein. Possibly the WTRU may be configured to prioritize the samples from the default dataset.

The WTRU may be configured to construct the third dataset based on randomized selection of samples from constituent datasets. For example, the WTRU may be configured to select samples following a uniform probability distribution. In another example, each constituent dataset may be associated with a sample selection probability. The WTRU may be configured to select the samples from the constituent dataset(s) following the sample selection probability associated with the constituent dataset.

The WTRU may be configured to construct the third dataset based on clustering of the samples from the constituent datasets. In order to reduce the number of data points in the third dataset different clustering-based approaches can be utilized. For example, K-Means styled clustering could be utilized with a predefined number of desired clusters, possibly reducing the overall size of the data to the number of specified clusters. Additionally, depending on the performance requirements, some parts of the dataset may be separately clustered so as to have fewer resulting data points, whereas the other parts of the data may be separately clustered to have a greater number of resulting data points.

The WTRU may be configured with a set of filtering rules for samples for dataset construction. The filtering rules may be applied on each constituent dataset before sample selection for third dataset. In another example, the filtering rules may be applied after the creation of third dataset. For example, the WTRU may apply one or more filtering rules on the third dataset to construct a fourth dataset. The filtering rules may be configured to reduce redundancy in the constructed dataset. For example, the WTRU may be configured to ensure that the constituent dataset(s) are different in a statistical sense, possibly to avoid redundancy in training samples. For example, the WTRU may be configured with similarity criteria that needs to be satisfied for dataset construction. For example, the WTRU may be configured to select dataset constituents that has a different mean and standard deviation from each other. In a solution, the WTRU may be configured to select dataset samples such that they are different from the previous datasets shared with the network.

Another form of filtering may be utilized towards reducing or increasing the number of data points by linear or non-linear operations that would generate new data points. For example, a weighted sum of two datapoints may be performed to generate a new data point in the data space. Such linear or non-linear operations may involve two or more data points to generate new data points. In the cases where certain regions of the data space are sparse, with very few data points, new data points can be generated to improve the training. The data points could be generated by performing the linear/non-linear filtering operation within one of the datasets or across the two datasets. Additionally, if the number of data points in some regions of the data space are very large, a single filtered combination of multiple neighboring points could be used to replace the multiple data points.

The WTRU may be configured to apply the third dataset to (re)train/fine-tune the WTRU side AI/ML encoder. The WTRU may construct a fourth dataset based on the training outcome of the WTRU side AI/ML encoder using the third dataset. For example, the WTRU may select the samples from the third dataset that satisfies a preconfigured condition to form a fourth dataset. For example, the WTRU may select samples from the third dataset that result in average gradients above a preconfigured threshold. For example, the WTRU may select the samples from the third dataset that results in at least one gradient above a preconfigured threshold. The WTRU may construct fourth dataset based on inference results of retrained WTRU side AI/ML encoder. For example, the fourth dataset may include the input to the retrained WTRU side AI/ML encoder and the corresponding output from the WTRU side AI/ML encoder. The WTRU may report or indicate the contents or parameters associated with the third or fourth dataset to an associated NW node.

The WTRU may be preconfigured with logical identity associated with each of the constituent datasets. The WTRU may be explicitly indicated by the gNB to select a subset of constituent datasets for construction of third dataset. For example, the gNB may indicate the logical identities of constituent datasets to be used for construction of third dataset.

A WTRU may receive or transmit a dataset or a subset of a dataset or an element of a dataset. A received dataset may be used to train, retrain, update, and/or fine-tune a WTRU AI/ML model (e.g., AI/ML encoder). A transmitted dataset may have been used to train/retrain/update/fine-tune a WTRU AI/ML model (e.g., AI/ML encoder). In an example, a WTRU may share a dataset with the NW and may indicate whether it has been used for training an AI/ML model at the WTRU.

A WTRU may transmit a dataset or a subset thereof to another node. The WTRU may be triggered to transmit a dataset, where the trigger condition may be based on at least one of: (1) an indication from a NW node; (2) a connection to a new node (e.g., NW node); (3) a dataset determined as not suitable; (4) new dataset samples or elements generated at the WTRU; (5) a measurement(s); (6) a new dataset construction; (7) a difference between a new dataset and a previously exchanged dataset; (6) AI/ML model training being triggered; (8) AI/ML model training completed; (9) time duration; (10) new function configured to use the AMIL model; (11) new functions configured to use the AI/ML model; and (12) the evaluated AI/ML model evaluated not being suitable.

If the trigger condition is based on an indication from a NW node, the NW may request that a WTRU transmit a dataset.

If the trigger condition is based on a connection to a new node, a WTRU may be provided resources on which to transmit a dataset when connecting to the new node.

If the trigger condition is based on a dataset determined as not suitable, the suitability of a dataset may be determined at the WTRU or at another node.

If the trigger condition is based on new dataset samples or elements generated at the WTRU, the WTRU may determine if the one or more new dataset samples are significantly different from those of a known dataset. The WTRU may determine the significant difference as a function of a metric obtained from one or more pairs of AI/ML encoder inputs and outputs. The metric may be compared to one or more threshold(s). The metric may include GCS or SGCS, or distance or correlation coefficient. Based on the comparison, the WTRU may determine to which dataset a new element belongs to (for example, possibly a pre-existing dataset or a new dataset) and whether adding the element to a pre-existing dataset significantly affects training done with the dataset. The WTRU may be triggered to transmit a dataset element or an updated dataset or a new dataset, based on if it has determined whether the dataset element or updated dataset or new dataset significantly affects AI/ML model training. Significantly affecting AI/ML model training may be defined as a minimum change in one or more AI/ML model parameter or performance.

If the trigger condition is based on measurements, a WTRU may, for example, determine whether a scenario or configuration has changed. If the scenario or configuration has changed, the WTRU may be triggered to transmit a dataset (e.g., a dataset applicable to the new scenario or configuration).

The trigger condition may be based on a new dataset construction, when, for example, a WTRU constructs a new dataset from elements of other datasets.

The trigger condition may be based on a difference between a new dataset and a previously exchanged dataset. For example, a WTRU may determine the difference between datasets in terms of GCS or SGCS value, or AI/ML model parameters, or training metric (e.g., number of elements required for convergence of the model).

The trigger condition may be based on a time duration. For example, a WTRU may be triggered to transmit a dataset after a configurable number of time slots or instances from a previous transmission of a dataset, from a previous application of a dataset, from a previous reception of a dataset, or from a generation of a dataset.

The trigger condition may be based on a new function configured to use the AI/ML model. For example, a generalized AI/ML model may be used for multiple functions. When the WTRU is configured or is triggered or determines to use the AI/ML model for a new function, the WTRU may be triggered to transmit a dataset.

The trigger condition may be based on an AI/ML model evaluated as not suitable. The AI/ML model suitability may be determined at the WTRU or at another node.

A WTRU may receive or expect to receive a dataset or a subset when at least one of the following occurs:

A WTRU may receive or expect to receive a dataset or a subset when a WTRU connects to a new node (e.g., NW node). For example, a WTRU may indicate to a NW node the one or more dataset(s) for which its AI/ML encoder is trained. The WTRU may then receive a new dataset or an updated dataset from the NW. An updated dataset may include a set of elements to be added or removed from a dataset known to the WTRU.

A WTRU may receive or expect to receive a dataset or a subset when a known time period elapses. For example, a WTRU may expect a new or updated dataset after a fixed time period has elapsed since using or being configured with a previous dataset.

A WTRU may receive or expect to receive a dataset or a subset when a new function relying on AI/ML is configured or triggered.

A WTRU may receive or expect to receive a dataset or a subset when an AI/ML model is determined (by the WTRU or NW) as not suitable.

A WTRU may receive or expect to receive a dataset or a subset when a scenario or configuration is changed.

A WTRU may receive or expect to receive a dataset or a subset when any of the triggers used for dataset transmission may also be used for a WTRU to begin monitoring for the reception of a dataset from another node.

A WTRU may request a new or updated dataset from another node (e.g., a NW node). The WTRU may transmit a dataset request on a configurable resource. For example, a WTRU may transmit a dataset request in a UCI, MAC CE, or RRC resource.

The WTRU may be triggered to request for a new dataset. The dataset request transmission trigger may depend on an AI/ML model suitability evaluation outcome. The AI/ML model suitability may be determined at the WTRU or at another node, as defined herein.

The dataset request transmission trigger may depend on when the WTRU is triggered by another node to train a new WTRU model. For example, a WTRU may be connected to multiple NW nodes or models. When a WTRU is triggered to retrain its model for operation with a first NW model, the WTRU may request a dataset associated with the first or a second NW model.

The dataset request transmission trigger may depend on time. For example, the WTRU may be triggered to request a new model when a period of time elapses. The period of time may start when a WTRU last trained an AI/ML encoder, or last used a dataset associated with the NW model or NW node or scenario or configuration.

The dataset request transmission trigger may depend on any of the triggers described herein for training an AI/ML model may be used for triggering a dataset request transmission.

The dataset request transmission trigger may depend on any of the triggers described herein for the transmission or reception of a dataset may be used for triggering a dataset request transmission.

Determination that a dataset is no longer applicable to train an AI/ML model associated with at least one of: a scenario, a configuration, a function, a NW model, a NW node.

A WTRU may include the trigger or cause of a dataset request in a dataset request message. A WTRU may also include one or more parameters of the desired dataset. For example, the WTRU may indicate a desired size or associated scenario or configuration of a dataset. In another example, a WTRU may request a specific content of a dataset, where dataset content is defined herein.

A WTRU may determine whether a dataset is applicable to be used for training of an AI/ML model encoder associated with at least one of: a scenario, a configuration, a function, a NW model, or a NW node. The determination of a dataset applicability may reuse methods described herein to determine the AI/ML model suitability.

A WTRU may be configured with a time duration. Upon elapsing of the time duration, the WTRU may determine that a dataset is no longer applicable.

The time duration may begin when a WTRU trains an AI/ML model encoder using the dataset. The time duration may begin when a WTRU received or generates the dataset. The time duration may begin when a WTRU transmits the dataset to another node. The time duration may begin when a WTRU updates the dataset. The time duration may begin when a WTRU is configured with an AI/ML model. The time duration may begin when a WTRU uses an AI/ML model for a new scenario, or configuration, or function, or NW model, or NW node.

A WTRU may be triggered to retrain an AI/ML encoder to operate with more NW models. The WTRU may determine a training dataset that is applicable to the multiple NW models and determines a dataset to share with at least one NW node to enable NW-side AI/ML training.

First, a WTRU may be configured with an AI/ML model (encoder) and a first dataset associated to a first NW node (and/or model, scenario, and/or configuration), and dataset construction constraints. For example, dataset construction constraints may include a maximum dataset size, dataset similarity comparison thresholds (e.g., to reduce redundancy).

The WTRU may then be triggered to update its AI/ML model encoder to operate with a second NW node (and/or second model, scenario, and/or configuration). For example, the WTRU may receive configurations to operate with a second NW node.

The WTRU may then obtain a second dataset associated with the second NW node (and/or second model, scenario, and/or configuration). The second dataset may be obtained via WTRU measurements, transfer from a NW node, and/or a pre-configuration.

The WTRU may then construct a third dataset from a combination of the first and second datasets. The WTRU may use all of one or both datasets, or may use subsets of one or both datasets. Construction can be based on redundancy reduction, randomized selection, previously used dataset.

The WTRU may then train (or re-trains/fine-tune) the AI/ML model encoder using the third dataset.

The WTRU may then select one or more third dataset samples that achieve at least one dataset construction constraint. For example, the WTRU may select dataset samples that satisfy the dataset similarity comparison threshold. For example, the WTRU may select dataset samples that maximize the gradient when training the AI/ML model encoder. For example, the WTRU selects dataset samples that were not previously shared with the NW.

The WTRU may then determine a fourth dataset from the selected one or more third dataset samples such that the fourth dataset size is less than or equal to the maximum dataset size.

The WTRU may then report the fourth dataset to the second NW node. The WTRU may also indicate that AI/ML model encoder is trained. The WTRU may also indicate the training parameters and/or the AI/ML model encoder parameters.

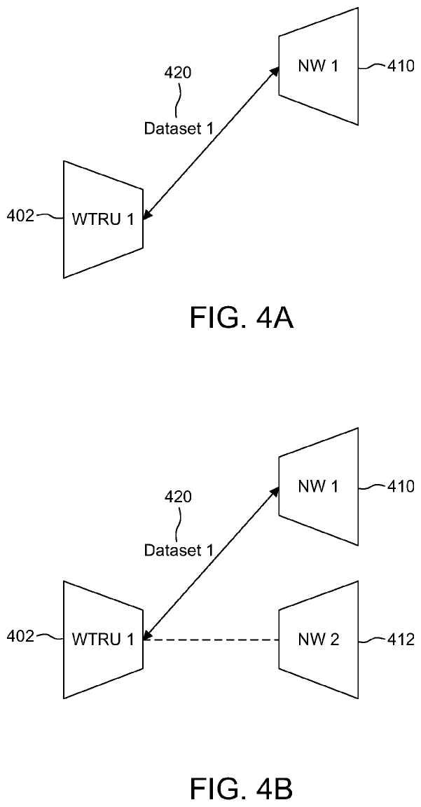

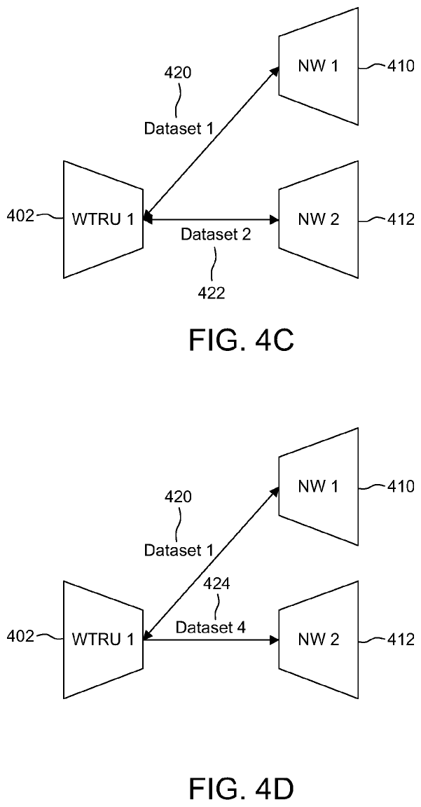

FIG. 4A to 4D illustrate a dataset construction and sharing to enable a generalized WTRU-side AI/ML model. As shown in FIG. 4A, a WTRU 402, configured with a first dataset 420, may be trained to operate with a first network 410.

Next, as shown in FIG. 4B, the WTRU 402 may be triggered to update its AI/ML encoder to operate with the first network 410 and a second network 412.

Next, as shown in FIG. 4C, the WTRU 402 may obtain a second dataset 422, where the second dataset 422 that is associated with the second network 412. The WTRU may then construct a third dataset from both the first dataset 420 and second dataset 422.

Next, as shown in FIG. 4D, the WTRU 402 may determine a fourth dataset 424 (e.g., subset of the third dataset). The WTRU 402 may share the fourth dataset 424 with the second network 412 such that the second network 412 can train its AI/ML decoder accordingly.

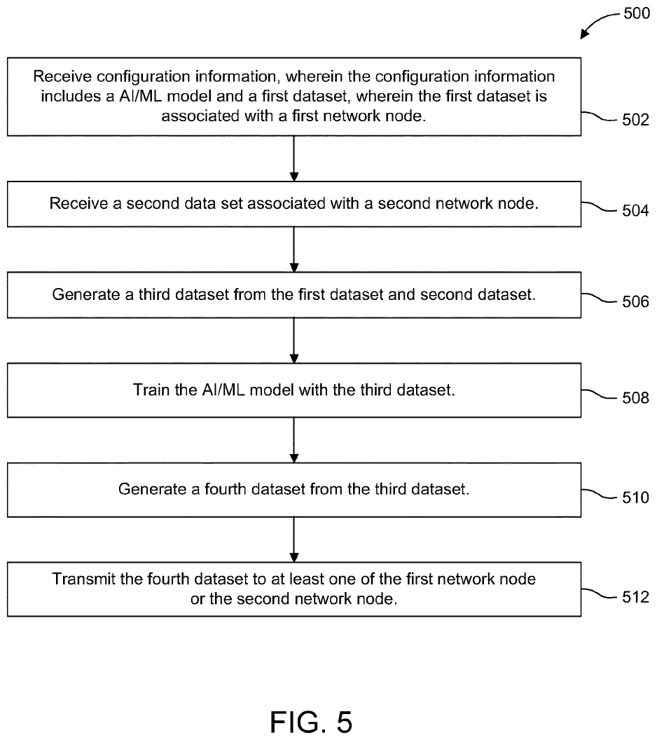

FIG. 5 illustrates a flowchart of an example procedure performed by a WTRU configured with an AI/ML model. As 502, a WTRU may receive configuration information. The configuration information may include an AI/ML model and a first dataset, where the first dataset is associated with a first network node. At 504, the WTRU may receive a second data set associated with a second network node. At 506, the WTRU may generate a third dataset from the first dataset and second dataset. At 508, the WTRU may train the AI/ML model with the third dataset. At 510, the WTRU may generate a fourth dataset from the third dataset. At 512, the WTRU may transmit the fourth dataset to at least one of the first network node or the second network node.

A WTRU using two-sided AI/ML models (e.g. AI/ML encoder models) may operate in a system with one or more NW nodes, where the AI/ML decoder models reside at the NW nodes. The WTRU may be configured with triggers to perform model (e.g., AI/ML encoder model) training, retraining, and/or fine-tuning.

A trigger to perform WTRU-side AI/ML model training, retraining, and/or fine tuning may include an outcome of the AI/ML model suitability evaluation. For example, the evaluation outcome may be that the WTRU-side model (AI/ML encoder model) is not suitable for the current operating conditions. When the model is deemed not suitable, WTRU-side model training, retraining, and/or fine-tuning may be triggered.

Triggers to perform WTRU-side AI/ML model training, retraining, and/or fine-tuning may include a change, addition, and/or deletion of associated NW node model(s). For example, the NW node the WTRU is associated to may retrain its NW-side model, or it may switch to use a different model, possibly with different backbone, or it may add a new model. The WTRU may receive an indication of the new or updated NW-side model or model ID from the associated NW node. The indication may include an identifier for the NW-side model, model type, size, operating scenario and/or configuration. In this case, the WTRU-side model training, retraining, and/or fine-tuning may be triggered.

Triggers to perform WTRU-side AI/ML model training, retraining, and/or fine-tuning may include a WTRU-side model generalization for one or more additional NW node(s). For example, a WTRU with a model trained to operate with a first NW node (e.g., with a first NW-side model type and/or a first set of scenarios/configurations) may additionally connect to a second NW node (e.g. in dual connectivity or multi connectivity configurations). When the NW-side model of the second NW node, and/or the second set of scenarios/configurations are different from the first NW node (for example, for different antenna panel layouts), the WTRU-side AI/ML model may no longer meet the target performance when operating with the second NW node. This may trigger training, retraining, and/or fine-tuning of the WTRU-side model to generalize for operation (e.g. joint operation) with the first and second NW nodes and the associated scenarios/configurations.

Triggers to perform WTRU-side AI/ML model training/retraining/finetuning may include the generation (by the WTRU) of a new dataset (e.g., for at least one WTRU model). For example, the WTRU may construct a new dataset for operating in a second set of scenarios/configurations. The WTRU may be triggered to train/retrain/finetune its model when it completes the data collection for the new dataset, e.g. when it collects the configured number of samples.

Triggers to perform WTRU-side AI/ML model training, retraining, and/or fine-tuning may include the performance of function using the AI/ML model. For example, a WTRU using a two-sided model for CSI compression may monitor the CSI feedback performance. In one solution, the WTRU may monitor local (e.g., WTRU side) performance indicators (e.g., SGCS, NMSE or the like) and determine that WTRU-side model needs training/retraining/finetuning when the measured performance does not meet the configured threshold. In another solution, the WTRU may monitor function specific performance indicators, such as the ACK/NACK statistics; when the number or the percentage of NACK during a measurement interval exceeds the configured threshold, the WTRU may be triggered to training, retraining, and/or fine-tuning its AI/ML model.

Triggers to perform WTRU-side AI/ML model training, retraining, and/or fine-tuning may include a change of scenario or configuration. For example, the WTRU may determine that the current operating scenario and/or configuration does not match the scenario and/or configuration used in the training dataset. The WTRU may receive information on the parameters of the training dataset (e.g. parameters of the scenario and/or configuration), for example, when configured with the AI/ML model, via parameters associated with the model ID which can be signaled or pre-defined. The mismatch between the current operating scenario and/or configuration and the training dataset may occur when any of the following current conditions is different from the value or range in the training dataset: WTRU determined current speed, the channel coherence time/bandwidth measured by the WTRU; the statistics of the channel response measured by the WTRU; current SNR experience by the WTRU; and/or configured antenna panel layout

Triggers to perform WTRU-side AI/ML model training, retraining, and/or fine-tuning may include a change of deployment (e.g. indoors vs. outdoors).

Triggers to perform WTRU-side AI/ML model training, retraining, and/or fine-tuning may include a change of function (e.g., for a model that is used for multiple functions). For example, the same WTRU model may be used for CSI compression with multiple pre-processing types (such as spatial-frequency pre-processing, angular-delay domain pre-processing, beam domain pre-processing or the like); in this case, training, retraining, and/or fine-tuning the model may be triggered when the WTRU switches the pre-processing type.

Triggers to perform WTRU-side AI/ML model training, retraining, and/or fine-tuning may include an indication from the gNB: the WTRU may perform training/retraining/fine tuning of the WTRU-side model when the WTRU receives an indication from the gNB, e.g. explicitly via RRC configuration, MAC CE or DCI, or implicitly when the WTRU receives a notification from the gNB to fallback to legacy processing (e.g. legacy CSI feedback processing).

An AI/ML model and/or encoder suitability evaluation may be referred to as a validation evaluation. Suitability may be defined as whether an AI/ML model (e.g., WTRU AI/ML model/encoder) has converged to provide a meaningful or useable output for a specific scenario, configuration, NW AI/ML model, NW node, NW side decoder etc. The suitability may be defined as a performance metric. Suitability evaluation may be to determine if the performance metric achieves a desired value.

A WTRU may evaluate (or enable NW-node evaluation of) the suitability of an AI/ML model.

The suitability evaluation performed at the WTRU may be determined from an updated and/or a new dataset (or part thereof). The suitability evaluation performed at the WTRU may be determined from a new dataset from merging datasets (e.g., due to connecting to a new node or due to generalization). For example, the encoder at the WTRU may be generalized to work with multiple decoders at the network (at one or more base stations, TRPs, and/or NW node(s)) corresponding to one or more scenarios and/or configurations. The WTRU may create and/or receive a new dataset, for example, by the merging of separate datasets for the respective scenarios, configurations, and/or base stations.

The suitability evaluation performed at the WTRU may be determined from a new dataset or part thereof (e.g., due to connecting to a new node). For example, the WTRU may obtain a new dataset, for example, from the network due to connecting to a new node (e.g., new TRP). The WTRU may assess the encoder suitability with the new dataset.

The suitability evaluation performed at the WTRU may be determined from an updated dataset with new WTRU-generated measurements. The WTRU may perform data collection via data collection frameworks activated at the WTRU (e.g., MDT, CSI reporting framework, and/or RRM) to build and/or expand the existing dataset and assess the model suitability against the updated/expanded dataset.

The suitability evaluation performed at the WTRU may be determined from a WTRU-identified or indicated change in scenario and/or configuration.

The suitability evaluation performed at the WTRU may be determined from comparing new dataset to previously used dataset and determining if they are substantially different. For example, if datasets are substantially different, then suitability evaluation may determine that the model is not suitable. The WTRU may determine a divergence value (a metric that determines how different two datasets are). The divergence may be determined from a comparison of one or more metrics obtained from each dataset. For example, a dataset may have a metric obtained from an average measurement, where the average is obtained over all the samples or elements of a dataset. The average measurements may include at least one of: an average RSRP, an average RSSI, an average RSRQ, an average SINR, an average CQI, an average delay spread, an average doppler spread, an average delay, an average Doppler shift, an average speed, an average CO, an average AoA, an average AoD, an average, an average GCS, or an average SGCS. The WTRU may compare the divergence value between two datasets against a threshold to determine if the datasets are substantially different (e.g., if the divergence value is greater than the threshold).

The suitability evaluation performed at the WTRU may be determined from an updated paired outputs-reconstructed inputs, received from a NW node for at least one NW model. For example, comparison of a WTRU-generated paired input-output with a NW-generated paired output-reconstructed input, against a threshold. The comparison may yield a value (e.g., error, MSE) that may be compared to a desired performance metric. For example, if the error or MSE is greater than a threshold, the UE may determine that the model is not suitable.

The WTRU may receive the updated paired output-reconstructed input from the NW node periodically, aperiodically or event triggered (e.g., the WTRU sending a request to the NW). The comparison between a WTRU-generated paired input-output with a NW-generated paired output-reconstructed input may be performed periodically, aperiodically or may be triggered (e.g., following reception of the updated paired outputs-reconstructed inputs from the NW).

The suitability evaluation performed at the WTRU may be determined from past and/or historical paired outputs-reconstructed input, received from a NW node for the encoder from previous use of the encoder.

The suitability evaluation performed at the WTRU may be determined from the reception (from NW node) of an expected output for a known input. For example, the WTRU may receive, from a NW node, one or more required AI/ML encoder outputs (i.e., AI/ML decoder input) associated with one or more known AI/ML encoder inputs. The reception of the encoder outputs may be periodic, aperiodic, semi-persistently, and/or triggered.

The suitability evaluation performed at the WTRU may be determined from the reception (e.g., from NW node) of a table mapping encoder to corresponding decoder. For example, the WTRU may receive from the NW a mapping table with encoders and their corresponding decoders, e.g., via encoder ID and decoder ID. The WTRU may assess the suitability of the encoder with respect to the decoder by checking if the encoder ID is included as a suitable encoder to the decoder used at the network.

The suitability evaluation performed at the WTRU may be determined from the reception (e.g., from NW node) of a list of WTRU model IDs or vendors compatible with the decoder at the NW. For example, the decoder at the NW may be compatible with encoders from a selected list of model IDs or WTRU vendors. The WTRU may assess the suitability of the AI/ML encoder by comparing the model ID or WTRU vendor of the encoder (e.g., from the model ID or model metadata) with the list of compatible model IDs or WTRU vendors from the network.

The suitability evaluation performed at the WTRU may be determined from a comparison with another encoder-decoder pair. The WTRU may assess the suitability of an encoder by comparing its performance against another baseline encoder at the WTRU (e.g., with the input-output pair of the baseline encoder compared against the gNB generated output-reconstructed input pairs for that encoder). The output from that comparison (e.g., error, MSE) assessed against the error from the baseline encoder may determine suitability of the encoder. The baseline encoder used by the WTRU may be a reference encoder that the WTRU uses to assess the performance of any new encoder. In one example, the reference encoder may be an encoder adapted to a specific configuration/scenario/decoder. The WTRU may assess the performance of a new encoder generalized to work with multiple configurations/decoders.

The suitability evaluation performed at the WTRU may be determined from a comparison with a legacy function. For example, the WTRU may receive CSI-RS from the gNB and compute CSI parameters using the traditional CSI framework. For example, the WTRU may send a request for CSI-RS from the gNB to assess the suitability of a new encoder. The WTRU may receive the reconstructed uncompressed feedback (output of the decoder from the gNB from using the encoder-decoder pair) periodically to assess the performance of the encoder-decoder pair. The WTRU may compare the CSI parameters using the traditional CSI framework against the reconstructed uncompressed feedback from the network. Result from the comparison may be error. If the error is greater than a threshold, the WTRU may determine that the encoder is not suitable.

The suitability evaluation performed at the WTRU may be determined from monitoring (e.g., via measurements) scenario/configuration to see if it matches training assumptions. For example, the WTRU may be configured with thresholds corresponding to training assumptions and/or encoder suitability and/or encoder-decoder pair suitability. For e.g., encoder x may only be suitable for a certain SINR range; encoder y may have been trained on a dataset that was generated assuming FR1 operation and cannot operate optimally in higher frequency ranges, encoder-decoder pair A-B were previously trained assuming a certain Doppler range and can operate optimally under similar assumptions. As such, the WTRU may be configured with thresholds corresponding to the one or more following parameters and configured to make measurements thereof to assess model suitability: RSRP, RSRQ, SINR, SNR, CQI, PMI, RI, LI; interference measurements, BLER; channel coherence time, channel coherence bandwidth; throughput; path loss/indicator or absence thereof of LOS/NLOS; doppler, doppler spread, delay spread; position, velocity, direction of motion.

The suitability evaluation performed at the WTRU may be determined from an encoder and/or decoder type. For example, based on whether the UE encoder type matches the decoder type at the NW.

The suitability evaluation performed at the WTRU may be determined from a security and/or privacy considerations. Inter-operability between multiple parties for two-sided models (e.g., WTRU vendor for encoder and NW vendor for decoder) may have some privacy and/or security problems. For example, some WTRU vendors may only work with some NW vendors (and vice versa), irrespective of technical compatibility as described above. A WTRU may be configured to assess encoder suitability based on the list of allowed UE vendors for a particular decoder.

The suitability evaluation performed at the WTRU may be determined from static information about the model. For example, the WTRU may assess the suitability of an encoder and/or encoder-decoder pair based on static information/hyperparameters about the model which may include one or more of the following: model size; overhead associated with model; latency for model to generate output; training/retraining/finetuning frequency; size of dataset needed to train model; amount of data needed to fine-tune the model at the WTRU (e.g., if the model training is done elsewhere, for example, at the network or the WTRU vendor or OTT server and some fine-tuning is needed at the WTRU); and input/output type of model.

The WTRU may assess the suitability of an encoder and/or encoder-decoder pair based on static information/hyperparameters about the model based on latency for model to generate output. In one solution, if the latency of the encoder to generate an output is high, it may not work with a certain decoder at the NW that also takes a long time to generate an output. The WTRU may receive from the NW latency requirements for the encoder to ensure that the NW receives the reconstructed uncompressed feedback in a timely manner. In another solution, to achieve synchronization between the encoder at the WTRU and the decoder at the network, the latency for both sides to generated an output may need to be similar/within a threshold of each other. The WTRU may assess encoder suitability based on latency to generate output.

The suitability evaluation performed at the WTRU may be determined from a history of performance of the encoder/encoder-decoder pair at the WTRU.

The suitability evaluation performed at the WTRU may be determined from an indication from the NW. The WTRU may assess encoder suitability based on request from the network to check suitability of encoder. The WTRU may assess encoder suitability based on indication from network of an update to the decoder, e.g., new decoder used at NW or retraining of current decoder.

Suitability evaluation performed at the NW node may be enabled by the WTRU via transmission of updated paired input-output, transmitted to at least one NW node for at least one WTRU model/encoder. This be transmitted periodically and/or on request from the network and/or following reception of resources for transmission.

Suitability evaluation performed at the NW node may be enabled by the WTRU via transmission of legacy feedback report in addition to AI/ML encoded feedback report (i.e., for the same measurement). For example, the WTRU may receive CSI-RS from the NW and compute CSI parameters. The WTRU may send the CSI report to the NW which may compare the CSI parameters with the reconstructed uncompressed feedback (output of the decoder at the network).

Suitability evaluation performed at the NW node may be enabled by the WTRU via transmission of AI/ML encoded feedback report associated to one or more known inputs.

Suitability evaluation performed at the NW node may be enabled by the WTRU via a configuration (e.g., periodic/aperiodic/semi-persistent) reporting (or reception) of paired inputs-outputs).

Suitability evaluation performed at the NW node may be enabled by the WTRU via the reporting of a new dataset (e.g., WTRU-generated dataset).

Suitability evaluation performed at the NW node may be enabled by the WTRU via the reporting of new data points to add to existing dataset at the network. The dataset building/expansion may be done via immediate reporting of data points (e.g., via RRM or the traditional CSI reporting framework) and/or logging (e.g., logged MDT which collects data for some time and transmits the data to the NW once a condition is fulfilled and/or on request from the NW).

Suitability evaluation performed at the NW node may be enabled by the WTRU via the transmission of model ID of encoder or part thereof to NW. The model ID of the encoder may be a number and/or an ID consisting of alpha-numerical characters or may consist of separate fields where each field corresponds to different model parameters. For example, one field within the model ID corresponding to WTRU vendor ID, another field corresponding to the time of previous training, another field consisting of the configuration under which the previous training was done, etc. The WTRU may also transmit a part of the model ID corresponding to the relevant information, e.g., part of model ID pertaining to model training parameters. Transmission of model metadata of encoder or part thereof to NW. Similar to the model ID, the WTRU may retransmit all or a portion of the metadata of the encoder to the NW for the NW to determine encoder suitability.

Suitability evaluation output may be binary (pass or fail), and may be determined from a comparison to a threshold. The suitability evaluation output may have more granularity.

The WTRU may determine whether a model is suitable or not based on the above or based on a reception from the gNB indicating the gNB-determined suitability evaluation outcome.

A WTRU may perform suitability evaluation of an AI/ML model (e.g., encoder). A WTRU performing a suitability evaluation may mean that the WTRU determines the suitability of an AI/ML model (e.g., encoder) with or without NW assistance. A WTRU performing a suitability evaluation may mean that the WTRU assists the NW in determining the suitability of an AI/ML model.

A WTRU may be triggered to perform suitability evaluation. The trigger to perform suitability evaluation may include a trigger described herein for AI/ML model training/retraining/updating/fine-tuning.

The trigger to perform suitability evaluation may include a trigger to retrain an AI/ML model for a first dataset (or the completion of the training may trigger a suitability evaluation procedure of the model for a second dataset.

The trigger to perform suitability evaluation may include Reception or generation of a new dataset, or samples thereof. For example, the WTRU may be triggered to perform a suitability evaluation if a WTRU obtains new dataset samples and determines they are significantly different from the dataset(s) used to train the AI/ML model (e.g., based on a determined divergence value between the two datasets).

The trigger to perform suitability evaluation may include an indication or determination to generalize an AI/ML model (e.g., to operate with new scenario, or configuration, or function, or NW model, or NW node).

The trigger to perform suitability evaluation may include measurements. for example, a WTRU may be triggered to perform a suitability evaluation if it determines a measurement is above or below a, possibly configurable, threshold. Examples of measurements may include RSRP, RSSI, RSRQ, RI, PMI, CQI, SINR, Doppler spread, Doppler shift, Delay spread, Average Delay, AoA, AoD, CO, LBT, model training convergence metric, measurements associated with the AI/ML model input.

The trigger to perform suitability evaluation may include performance of an associated function. For example, a WTRU may be triggered to perform suitability evaluation if the performance of a function associated with an AI/ML model falls below a threshold. The performance may be determined from a metric of the function (e.g., HARQ-NACK rate) or from a metric comparing the output of the AI/ML model with the expected output. Where the expected output may be the original input, or an error-free value, or a value obtained using a legacy (e.g., non-AI/ML) method.

The trigger to perform suitability evaluation may include time. For example, the WTRU may be triggered to perform suitability evaluation periodically or at specific time instances.

The trigger to perform suitability evaluation may include an indication from a NW node. For example, the WTRU may receive an indication from a gNB via DCI or MAC CE or RRC. The indication may be an explicit order to perform suitability evaluation. In another example, the indication may be implicit (e.g., that the NW node has retrained an AI/ML model (e.g., decoder) associated with the WTRU).

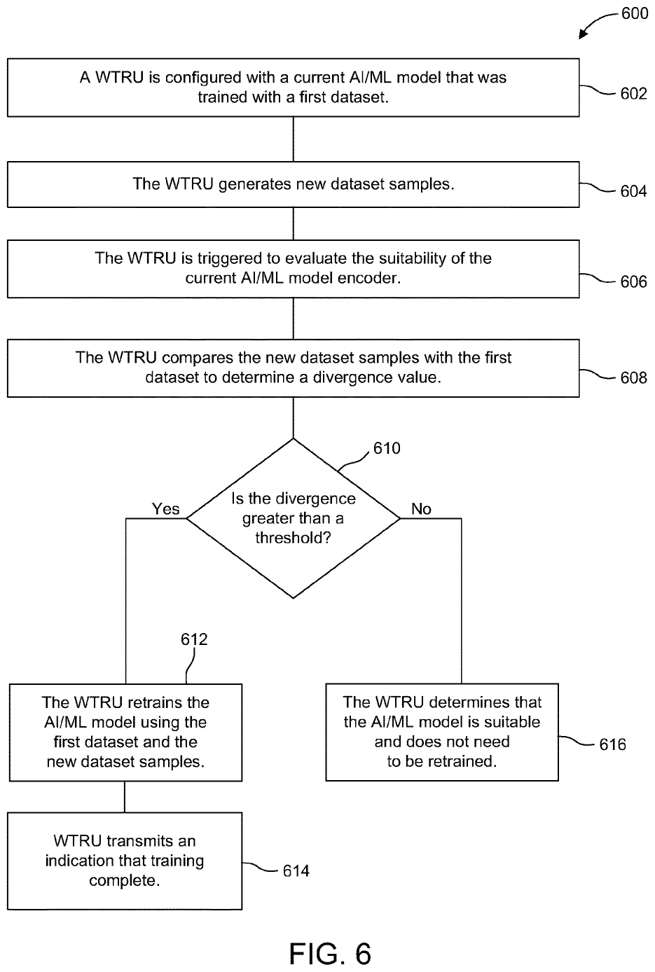

FIG. 6 is a flowchart illustrating an example procedure for a suitability evaluation based on comparing newly generated dataset samples with the dataset used for the original training. At 602, the WTRU is configured with and is operating with a current AI/ML model. The current AI/ML model was trained with a first dataset. The WTRU may also be configured with one or more suitability evaluation triggering conditions. The current AI/ML model may include a AI/ML encoder and an AI/ML decoder.

At 604, the WTRU may generate new datasets, including at least a second dataset. At 606, the WTRU may be triggered to evaluate the suitability of the current AI/ML model encoder. At 608, the WTRU may compare the new dataset samples with the first dataset and determine a divergence value. At 610, the WTRU may determine whether the divergence value is greater than a threshold.

At 612, if the divergence value is greater than a threshold value, the WTRU may retrain the current AI/ML model using the first dataset and the new dataset samples. After the retraining, at 612, the WTRU may transmit, to the network, an indication that the retraining is compete. The transmission may also include the dataset that was used to retrain the AI/ML model.

At 614, if the divergence is equal to or lower than a threshold, the WTRU may determine that the current AI/ML model is suitable and a retraining is not required.

A WTRU may be configured with triggers to determine if an AI/ML encoder is suitable and/or if AI/ML encoder (re)training is required. The WTRU may determine suitability as a function of, for example, newly obtained training dataset. The WTRU determines to retrain the AI/ML encoder as a function, for example, of suitability outcome. The WTRU may retrain the AI/ML encoder and share the training dataset with a NW node.

In one embodiment, a WTRU may be configured with a two-sided AI/ML model (e.g., encoder) and suitability evaluation triggering conditions. The suitability evaluation triggering conditions may include: determination to generalize the AI/ML model encoder for an additional NW model; reception or generation of a new dataset, measurements and/or measurement thresholds; performance of a function associated to the AI/ML model encoder; and/or change of scenario and/or configuration

The WTRU may then obtain a new dataset. The new dataset may be a WTRU-generated dataset or dataset indicated by the base station.

The WTRU may then determine that a suitability evaluation triggering condition is satisfied. For example, the triggering condition may be due to obtaining the new dataset.

The WTRU may then evaluate the suitability of the AI/ML model encoder with regards to the new dataset. The suitability evaluation may be done at the WTRU. The suitability evaluation may be done by testing the new dataset. For example, the WTRU may test if the new dataset is substantially different (or diverges) from a dataset previously used for training. The suitability evaluation may be done by comparing the input-output of the AI/ML model encoder with output-reconstructed input of the AI/ML model decoder (received from the base station). The suitability evaluation may be done by monitoring (e.g., via measurements) the scenario and/or configuration to determine if it matches the previous training assumptions. The suitability evaluation may be done by comparing the output of the AI/ML model encoder of a known input, to a received base station-desired output (potentially periodically received).

The suitability evaluation may be enabled by the WTRU and done at the base station. The suitability evaluation may include, for example, the WTRU reporting of a WTRU-generated dataset. The suitability evaluation may include the WTRU reporting of paired input-outputs (e.g., periodic reporting). The suitability evaluation may include the WTRU reporting of legacy feedback and compressed feedback (e.g., periodic reporting). The suitability evaluation may include the WTRU reporting of compressed output(s) for known input(s) (e.g., periodic reporting).

The WTRU may then determine that the current AI/ML model is not suitable. For example, the WTRU may determine that a new dataset is substantially different from a previously used dataset. For example, the WTRU may determine that its input-output pairs differ from the base station-generated output-reconstructed input pairs. For example, the WTRU may receive an indication from the base station that the model is not suitable.

The WTRU may then (re)train the AI/ML model encoder based on the model not being suitable, and obtains a new set of paired inputs-outputs. The WTRU may uses at least the new dataset for retraining.

The WTRU may then transmit an indication that WTRU-side training is complete. This indication may include the new dataset or the set of paired inputs-outputs associated with its trained AI/ML model encoder.

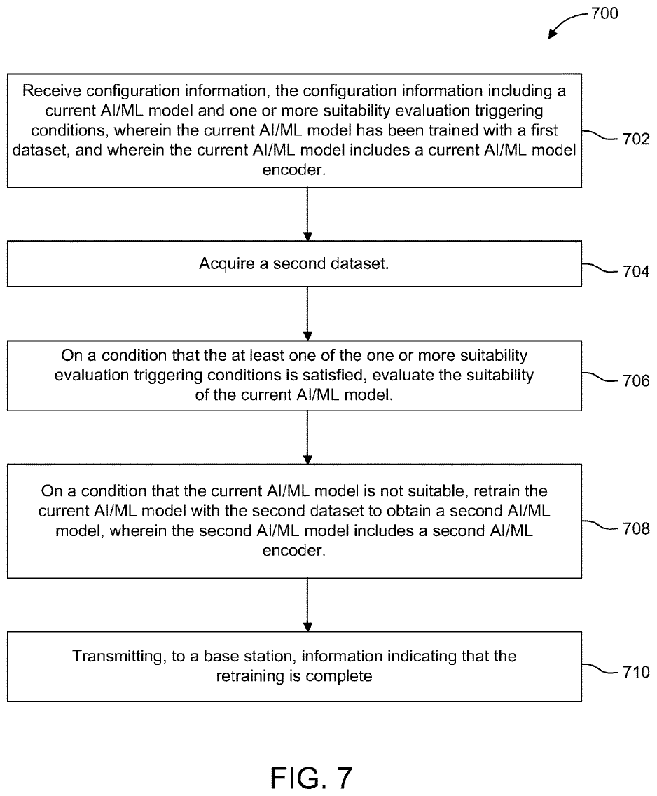

FIG. 7 illustrates a flowchart of an example procedure performed by a WTRU configured with an AI/ML model. At 702, the WTRU may receive configuration information. The configuration information may include a current AI/ML model and one or more suitability evaluation triggering conditions. The current AI/ML model may have been trained with a first dataset. The current AI/ML model may include a current AI/ML model encoder. At 704, the WTRU may acquire a second dataset. At 706, on a condition that the at least one of the one or more suitability evaluation triggering conditions is satisfied, the WTRU may evaluate the suitability of the current AI/ML model. At 708, on a condition that the current AI/ML model is not suitable, the WTRU may retrain the current AI/ML model with the second dataset to obtain a second AI/ML model, wherein the second AI/ML model includes a second AI/ML encoder. At 710, the WTRU may transmit, to a base station, information indicating that the retraining is complete.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a wireless transmit/receive unit (WTRU), the method comprising:
receiving configuration information, wherein the configuration information includes a AI/ML model and a first dataset, wherein the first dataset is associated with a first network node;
receiving a second data set associated with a second network node;
generating a third dataset from the first dataset and second dataset;
training the AI/ML model with the third dataset;
generating a fourth dataset from the third dataset; and
transmitting the fourth dataset to at least one of the first network node or the second network node.

2. The method of claim 1, wherein the WTRU is triggered to update the AI/ML model to operate with the second network node.

3. The method of claim 1, wherein the third dataset is based on a combination of the first dataset and the second dataset.

4. The method of claim 3, wherein the generation of the third dataset is based on a redundancy reduction, a randomized selection, or a previously used dataset.

5. The method of claim 1, further comprising:
selecting one or more samples from the third dataset.

6. The method of claim 5, wherein the selection of the one or more samples from the third dataset includes selecting dataset samples that satisfy a dataset similarity comparison threshold.

7. The method of claim 5, wherein the selection of the one or more samples from the third dataset includes selecting dataset samples that maximize a gradient when training the AI/ML model.

8. The method of claim 5, wherein the selection of the one or more samples from the third dataset includes selecting dataset samples that were not previously shared with the first network node.

9. The method of claim 5, wherein the fourth dataset is generated from the selected one or more samples of the third dataset.

10. The method of claim 1, wherein the fourth dataset is the same as the third dataset.

11. A wireless transmit/receive unit (WTRU), comprising:
a transceiver; and
a processor
wherein the transceiver and processor are configured to:
receive configuration information, wherein the configuration information includes a AI/ML model and a first dataset, wherein the first dataset is associated with a first network node;
receive a second data set associated with a second network node;
generate a third dataset from the first dataset and second dataset;
train the AI/ML model with the third dataset;
generate a fourth dataset from the third dataset; and
transmit the fourth dataset to at least one of the first network node or the second network node.

12. The WTRU of claim 11, wherein the WTRU is triggered to update the AI/ML model to operate with the second network node.

13. The WTRU of claim 11, wherein the third dataset is based on a combination of the first dataset and the second dataset.

14. The WTRU of claim 13, wherein the generation of the third dataset is based on a redundancy reduction, a randomized selection, or a previously used dataset.

15. The WTRU of claim 11, wherein the transceiver and processor are further configured to:
select one or more samples from the third dataset.

16. The WTRU of claim 15, wherein the selection of the one or more samples from the third dataset includes the selection of dataset samples that satisfy a dataset similarity comparison threshold.

17. The WTRU of claim 15, wherein the selection of the one or more samples from the third dataset includes the selection of dataset samples that maximize a gradient when training the AI/ML model.

18. The WTRU of claim 15, wherein the selection of the one or more samples from the third dataset includes the selection of dataset samples that were not previously shared with the first network node.

19. The WTRU of claim 15, wherein the fourth dataset is generated from the selected one or more samples of the third dataset.

20. The WTRU of claim 11, wherein the fourth dataset is the same as the third dataset.
